(19) United States
(12) Patent Application Publication
(10) Pub. No.: US 2004/0166941 A1
(43) Pub. Date: Aug. 26, 2004

(54) Communication system

(75) Inventor: Jun Fujimoto, Tokyo (JP)

Correspondence Address: Ronald R. Snider, P. O. Box 27613, Washington, DC, 20038-7613, US

(73) Assignee: Aruze Corp., Tokyo (JP)

(21) Appl. No.: 10/734,193

(22) Filed: Dec. 15, 2003

(30) Foreign Application Priority Data
Dec. 16, 2002 (JP) 2002-364483

(51) Int. Cl. A63F 13/00

(52) U.S. Cl. 463/42

(57) ABSTRACT

The present invention provides a communication system for a manager for managing a game to acquire information required for proceeding with the game from guests playing the game while staying in their guestrooms. A communication system 1 comprises a controller 12 within a first communication terminal 10 for managing whether a game ball is about to be introduced to a game board or not; a display device 23 within a second communication terminal 20 for displaying that the game ball is about to be introduced to the game board according to information managed by the controller 12; a controller 25 for acquiring an identifier of a pocket expected to receive the game ball and guest-specific information inputted by the guest 61 according to the display device 23; an output device 16, disposed in a game arcade, for outputting the information to a manager 51; and a local area network 71 existing between communication terminals 10, 20.

### RELATED APPLICATIONS

This application claims the priority of Japanese Patent Application No. 2002-364483 filed on Dec. 16, 2002, which is incorporated herein by reference.

### BACKGROUND OF THE INVENTION

1. Field of the Invention

The present invention relates to a communication system for carrying out communications of information concerning games played in game arcades.

2. Description of the Prior Art

Conventionally known are systems which lend a card recording information about a guest of an accommodation facility to the guest, thereby managing information about the guest. For example, the following technique has conventionally been known (see Japanese Unexamined Patent Publication No. 2002-123619, for example). At the time of check-in, the card records details registered by the guest. According to the card, the guest is provided with services. When the guest does shopping in the accommodation facility, the card records information such as the amount of money spent. At the time of check-out, the account is settled according to the card.

The above-mentioned card has also been in use in gaming industries such as casinos. For example, a technique performing a game by using a credit card has conventionally been known (see, for example, Japanese Unexamined Patent Publication No. HEI 8-180115 (paragraph [0038]).

However, the above-mentioned prior art has been problematic in the following points. For example, there are cases where a game is played under the control of a manager who manages the game (e.g., roulette game or poker game) in a game arcade (such as casino) placed in an accommodation facility. When guests want to enjoy playing such a game, they must go to the game arcade.

However, some guests may want to enjoy playing the game while staying in their rooms in the accommodation facility. It has conventionally been desired to develop a system which can realize the above. For realizing this, a manager for managing the game must acquire information required for proceeding with the game from guests playing the game while staying in their rooms.

### SUMMARY OF THE INVENTION

In view of the foregoing problems, it is an object of the present invention to provide a communication system in which a manager for managing a game can acquire information required for proceeding with the game from guests playing the game while staying in their rooms.

For overcoming the above-mentioned problems, the present invention provides a communication system for acquiring information required for proceeding with a game played in a game arcade from a predetermined guest playing the game and outputting thus acquired information to a manager for managing the game, the communication system comprising transmitting means, disposed in the game arcade, for transmitting instruction information indicative of an instruction to transmit the information required for proceeding with the game to a communication terminal of the guest; and information acquiring means for acquiring information required for proceeding with the game according to the instruction information in the communication terminal.

Preferably, the communication terminal comprises display means for displaying a predetermined information item according to the instruction information, and input means for causing the guest to input information required for proceeding with the game according to the predetermined information item displayed on the display means.

Preferably, the communication terminal comprises card reading means for reading guest-specific information specifying the guest stored in a predetermined guest card.

In another aspect, the present invention provides a communication system for a game using a game board provided with a plurality of pockets adapted to a game medium introduced, each pocket bearing an identifier, a predetermined guest using a gaming device for causing any of the pockets to receive the game medium and anticipating the identifier of the pocket; the communication system acquiring from the guest the identifier of the pocket expected to receive the game medium before the game medium is introduced to the game board and outputting the identifier to a manager for managing the game; the communication system comprising managing means, disposed in a game arcade where the game is played, for determining whether the game medium is about to be introduced to the game board or not; transmitting means, disposed in the game arcade, for transmitting information managed by the managing means and instruction information indicative of an instruction to transmit the identifier of the pocket expected to receive the game medium to a communication terminal disposed in the guestroom in an accommodation facility; display means, disposed in the guestroom of the accommodation facility, for displaying information indicating that the game medium is about to be introduced to the game board and the instruction information according to information managed by the managing means; information acquiring means, disposed in the guestroom of the accommodation facility, for acquiring the identifier of the pocket expected to receive the game medium inputted by the guest and guest-specific information for specifying the guest according to the display effected by the display means; and output means, disposed in the game arcade, for outputting the information acquired by the information acquiring means to the manager. Here, the word “introduce” means that a game medium is thrown into the game board.

Preferably, in this case, the communication terminal comprises communication means for transmitting the identifier of the pocket expected to receive the game medium inputted by the guest and the guest-specific information for specifying the guest as acquired by the information acquiring means.

Preferably, transmission of information from the transmitting means to the communication terminal and the transmission of information from the communication means toward the game arcade are carried out via a local area network.

Preferably, the guest-specific information is obtained by reading information specifying the guest stored in a predetermined guest card with at least card reading means disposed in the guestroom. Preferably, the card reading means is configured so as to be able to inscribe the predetermined guest card with a result of gaming transmitted from the game arcade.

Preferably, the display means displays information indicating that an entry to the game is currently acceptable together with the information indicating that the game medium is about to be introduced to the game board.

Preferably, the display means displays information indicating that the game medium is not about to be introduced to the game board. Preferably, the display means displays information indicating that the entry to the game is closed together with the information indicating that the game medium is not about to be introduced to the game board.

Preferably, the guestroom of the accommodation facility is provided with input means for the guest to input the identifier of the pocket expected to receive the game medium.

The game for introducing the game medium to the game board may be a roulette game.

In still another aspect, the present invention provides a communication system for a game providing a predetermined guest with a plurality of game cards storing respective identification information items and then replacing any of the game cards, the communication system acquiring information required for proceeding with the game from the predetermined guest playing the game and outputting thus acquired information to a manager for managing the game; the communication system comprising first information acquiring means for acquiring guest-specific information specifying a guest playing the game in relation to information indicating that the guest is in a game arcade where the game is played or information indicating that the guest is in a guestroom of an accommodation facility; second information acquiring means for acquiring the identification information items stored in the plurality of game cards in relation to positional information items indicative of the positions where the game cards are arranged for each guest-specific information; first transmitting means for transmitting the identification information items of the plurality of game cards related to the guest-specific information corresponding to the information indicating that the guest is in the guestroom and the positional information items respectively corresponding to the identification information items of the plurality of game cards to a communication terminal disposed in the guestroom where the guest stays; second transmitting means for transmitting instruction information indicative of an instruction to transmit information concerning any of the game cards to the communication terminal if the game card is desired to be replaced; third information acquiring means for acquiring the positional information item corresponding to the identification information item of one or a plurality of the game cards desired to be replaced by the guest in the identification information items of the plurality of game cards according to the instruction information in the communication terminal; and output means, disposed in the game arcade, for outputting one or a plurality of positional information items acquired by the third information acquiring means to the manager.

Preferably, in this case, the communication terminal comprises communication means for transmitting the positional information items corresponding to the identification information items of one or a plurality of the game cards desired to be replaced by the guest in the identification information items of the plurality of game cards as acquired by the third information acquiring means.

Preferably, the guestroom of the accommodation facility is provided with display means for displaying the identification information items of the plurality of game cards related to the guest-specific information corresponding to the information indicating that the guest is in the guestroom and the positional information items corresponding to the identification information items of the plurality of game cards transmitted to the communication terminal.

Preferably, the transmission of information from the transmitting means to the communication terminal and the transmission of information from the communication means toward the game arcade are carried out via a local area network.

Preferably, the guest-specific information is obtained by reading information specifying the guest stored in a predetermined guest card with at least card reading means disposed in the guestroom.

Preferably, the card reading means is configured so as to be able to inscribe the predetermined guest card with a result of gaming transmitted from the game arcade.

Preferably, when any of the game cards is desired to be replaced, the display means displays instruction information indicating an instruction to input information concerning the game card desired to be replaced.

Preferably, the guestroom of the accommodation facility is provided with input means for inputting the positional information item corresponding to one or a plurality of the game cards desired to be replaced by the guest.

Preferably, the identification information of each game card is stored in an IC tag incorporated in the game card.

The game using the game cards may be a poker game.

In still another aspect, the present invention provides a communication system for acquiring information required for proceeding with a game played in a game arcade from a predetermined guest playing the game and outputting thus acquired information to a manager for managing the game; the communication system comprising first and second communication system functions; the first communication system function being employed for a first game using a game board provided with a plurality of pockets adapted to receive a game medium introduced, each pocket bearing an identifier, a predetermined guest using a gaming device for causing any of the pockets to receive the game medium and anticipating the identifier of the pocket, the first communication system function acquiring from the guest the identifier of the pocket expected to receive the game medium before the game medium is introduced to the game board and outputting thus acquired identifier to a manager for managing the first game; the second communication system function being employed for a second game providing the predetermined guest with a plurality of game cards storing respective identification information items and then replacing any of the game cards, the second communication system function acquiring information required for proceeding with the game from the predetermined guest playing the second game and outputting thus acquired information to a manager for managing the second game; the guestroom of an accommodation facility where the guest stays being provided with setting input means for the guest to input whether the first or second communication system function is used for playing the games, any of the first and second communication system functions being operated according to the input from the setting input means.

In still another aspect, the present invention provides a communication system for acquiring information required for proceeding with a game played in a game arcade from a predetermined guest playing the game and outputting thus acquired information to a manager for managing the game; the communication system comprising a transmitter, disposed in the game arcade, for transmitting instruction information indicative of an instruction to transmit the information required for proceeding with the game to a communication terminal of a game participant; and an information acquiring device for acquiring information required for proceeding with the game according to the instruction information in the communication terminal.

In still another aspect, the present invention provides a communication system for a game using a game board provided with a plurality of pockets adapted to receive a game medium introduced, each pocket bearing an identifier, a predetermined guest using a gaming device for causing any of the pockets to receive the game medium and anticipating the identifier of the pocket; the communication system acquiring from the guest the identifier of the pocket expected to receive the game medium before the game medium is introduced to the game board and outputting thus acquired identifier to a manager for managing the game; the communication system comprising a managing device, disposed in a game arcade where the game is played, for determining whether the game medium is about to be introduced to the game board or not; a transmitter, disposed in the game arcade, for transmitting information managed by the managing device and instruction information indicative of an instruction to transmit the identifier of the pocket expected to receive the game medium to a communication terminal disposed in the guestroom in an accommodation facility; a display device, disposed in the guestroom of the accommodation facility, for displaying information indicating that the game medium is about to be introduced to the game board and the instruction information according to information managed by the managing device; an information acquiring device, disposed in the guestroom of the accommodation facility, for acquiring the identifier of the pocket expected to receive the game medium inputted by the guest and guest-specific information for specifying the guest according to the display effected by the display device; and an output device, disposed in the game arcade, for outputting the information acquired by the information acquiring device to the manager.

In still another aspect, the present invention provides a communication system for a game providing a predetermined guest with a plurality of game cards storing respective identification information items and then replacing any of the game cards, the communication system acquiring information required for proceeding with the game from a predetermined guest playing the game and outputting thus acquired information to a manager for managing the game; the communication system comprising a first information acquiring device for acquiring guest-specific information specifying a guest playing the game in relation to information indicating that the guest is in a game arcade where the game is played or information indicating that the guest is in a guestroom of an accommodation facility; a second information acquiring device for acquiring the identification information items stored in the plurality of game cards in relation to positional information items indicative of the positions where the game cards are arranged for each guest-specific information; a first transmitter for transmitting the identification information items of the plurality of game cards related to the guest-specific information corresponding to the information indicating that the guest is in the guestroom and the positional information items respectively corresponding to the identification information items of the plurality of game cards to a communication terminal disposed in the guestroom where the guest stays; a second transmitter for transmitting instruction information indicative of an instruction to transmit information concerning any of the game cards to the communication terminal if the game card is desired to be replaced; a third information acquiring device for acquiring the positional information item corresponding to the identification information item of one or a plurality of the game cards desired to be replaced by the guest in the identification information items of the plurality of game cards according to the instruction information in the communication terminal; and an output device, disposed in the game arcade, for outputting one or a plurality of positional information items acquired by the third information acquiring device to the manager.

In still another aspect, the present invention provides a communication system for acquiring information required for proceeding with a game played in a game arcade from a predetermined guest playing the game and outputting thus acquired information to a manager for managing the game; the communication system comprising first and second communication system devices; the first communication system device being employed for a first game using a game board provided with a plurality of pockets adapted to receive a game medium introduced, each pocket bearing an identifier, a predetermined guest using a gaming device for causing any of the pockets to receive the game medium and anticipating the identifier of the pocket, the first communication system device acquiring from the guest the identifier of the pocket expected to receive the game medium before the game medium is introduced to the game board and outputting thus acquired identifier to a manager for managing the first game; the second communication system device being employed for a second game providing the predetermined guest with a plurality of game cards storing respective identification information items and then replacing any of the game cards, the second communication system device acquiring information required for proceeding with the game from the predetermined guest playing the second game and outputting thus acquired information to a manager for managing the second game; the guestroom of an accommodation facility where the guest stays being provided with a setting input device for the guest to input whether the first or second communication system device is used for playing the games, any of the first and second communication system devices being operated according to the input from the setting input device.

### BRIEF DESCRIPTION OF THE DRAWINGS

FIG. 1 is a diagram showing the configuration of the communication system in accordance with an embodiment 1 of the present invention;

FIG. 2 is a schematic view showing an example of a gaming table used in the communication system in accordance with the embodiment 1 of the present invention;

FIG. 3 is a diagram showing the configuration of an embodiment 2 of the communication system shown in FIG. 1; and

FIG. 4 is a schematic view showing a gaming table used in the communication system in accordance with the embodiment 2 of the communication system shown in FIG. 1.

### DESCRIPTION OF THE PREFERRED EMBODIMENTS

In the following, preferred embodiments of the present invention will be explained in detail with reference to the drawings.

Configuration

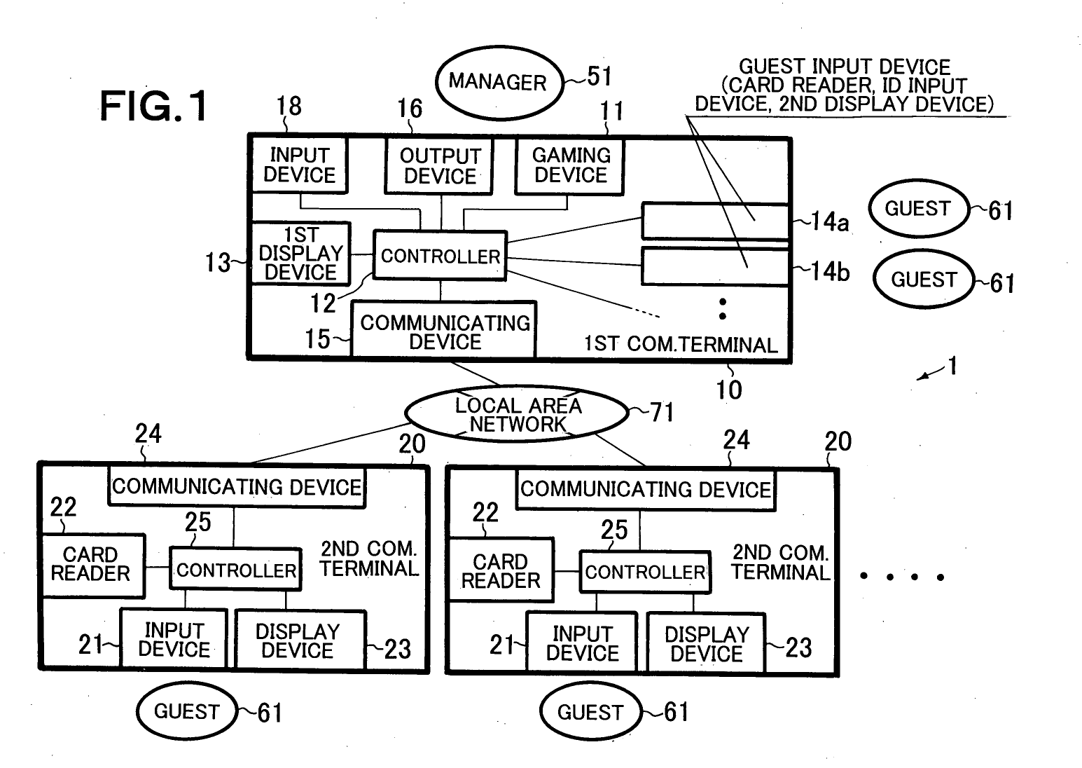

FIG. 1 is a diagram showing the configuration of the communication system 1 in accordance with an embodiment 1. The communication system 1 in accordance with this embodiment 1 is constructed in an accommodation facility, for example. In this example, for instance, the accommodation facility comprises a game arcade (e.g., casino), a plurality of guestrooms, and a front desk. The game arcade may be located outside of the accommodation facility as well.

The communication system 1 comprises a first communication terminal 10, and second communication terminals 20 connected to the first communication terminal 10 via a local area network 71, for example. The first communication terminal 10 is disposed in the game arcade. The second communication terminals 20 are disposed in the respective rooms.

A guest card is given to each of guests 61 of the accommodation facility during their stay. Upon reception at the front desk, each guest 61 is supplied with the guest card. The guest card stores guest-specific information (identification information, name, etc.) for specifying the guest 61, for example.

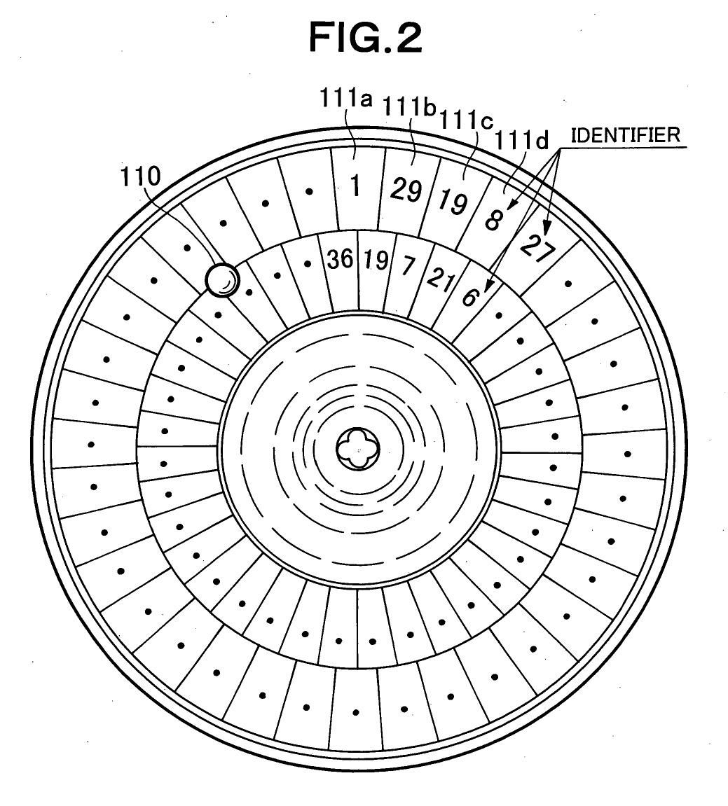

The first communication terminal 10 includes a gaming device 11. FIG. 2 is a view showing the exterior configuration of a gaming table which is a portion of the gaming device 11. In the gaming table, a plurality of pockets 111a, 111b, 111c, 111d, . . . which can receive a game ball 110 introduced onto the game board, are arranged. In the gaming table, the pockets 111a, . . . bear respective identifiers (1, 2, 3, 4, . . . ) such as number and letter. The game ball 110 is received by any of the pockets 111a . . . . The game in this embodiment 1 is one concerning whether a participant of the game can guess the identifier of the pocket which receives the game ball 110 by using the gaming table (gaming device 11). An example of such a game is a roulette game. However, this embodiment 1 is not restricted to the roulette game.

A manager 51 for managing the game is in the vicinity of the first communication terminal 10. For example, the manager 51 carries out such operations of acquiring the identifier of the pocket 111a, . . . expected to be received by the game ball 110 from each guest 61, introducing the game ball 110 to the game board, and determining whether each guest 61 wins or loses the game after introducing the game ball 110 to the game board.

After the game ball 110 is introduced to the game board, the gaming device 11 transmits the identifier of the pocket 111a, . . . having received the game ball 110 to a controller 12. The controller 12 outputs the identifier to an output device 16.

Without providing the first communication terminal 10 with the gaming device 11, the gaming table constructed independently of the first communication terminal 10 may be disposed in the game arcade. After introducing the game ball 110 to the game board, the manager 51 may solely determine the identifier of the pocket 111a, . . . having received the game ball 110.

The first communication terminal 10 includes the controller 12. The controller 12 manages whether the game ball 110 is about to be introduced to the game board or not.

An example of the managing operation by the controller 12 is as follows: When intending to introduce the game ball 110 to the game board, the manager 51 transmits the first predetermined data to the controller 12 by using an input device 18 of the first communication terminal. According to the first predetermined data, the controller 12 recognizes that the game ball 110 is not about to be introduced to the game board. When completing the operation of determining whether each guest 61 wins or loses the game after the game ball 110 is introduced to the game board, the manager 51 transmits the second predetermined data to the controller 12 by using an input device 18 of the first communication terminal. According to the second predetermined data, the controller 12 recognizes that the game ball 110 is about to be introduced to the game board.

The first communication terminal 10 includes a first display device 13 for displaying whether the game ball 110 is about to be introduced to the game board or not. According to the information sent from the controller 12 (information about whether the game ball 110 is about to be introduced to the game board or not), the first display device 13 carries out the operation mentioned above. When displaying the information indicating that the game ball 110 is about to be introduced to the game board, the first display device 13 also displays information indicating that an entry to the game is currently acceptable. When displaying the information indicating that the game ball 110 is not about to be introduced to the game board, the first display device 13 also displays information indicating that the entry to the game is closed.

The first communication terminal 10 also includes a plurality of guest input devices 14a, 14b, . . . . Each of the guest input devices 14a, . . . comprises a card reader, an ID information input device, and a second display device. When the first display device 13 displays the information indicating that an entry to the game is currently acceptable together with the information indicating that the game ball 110 is about to be introduced to the game board, the sections function as follows:

Each guest 61 brings a guest card closer to the card reader. Then, by noncontact communications, the card reader reads out the guest-specific information specifying the guest 61 stored in the guest card. The card reader sends the guest-specific information to the controller 12. The controller 12 causes the second display device to display an instruction to input the identification information of the pocket 111a, . . . expected to receive the game ball 110 (hereinafter referred to as expected identification information). According to the display, the guest 61 inputs the expected identification information by using the identification information input device. The expected identification information inputted by the identification information input device is sent to the controller 12. The expected identification information items inputted by one or a plurality of guests 61 playing the game and the respective guest-specific information items are sent to the controller 12. In the following, the expected identification information inputted by the guest 61 in the game arcade will be referred to as the first expected identification information. The controller 12 acquires and holds the guest-specific information and the first expected identification information (identifier of the pocket 111a, . . . expected to receive the game ball 110) for each guest 61 playing the game.

The first communication terminal 10 also includes a communicating device 15. The communicating device 15 sends the information indicating whether the game ball 110 is about to be introduced to the game board or not sent from the controller 12 to each second communication terminal 20 via the local area network 71. Here, the information indicating that the entry to the game is acceptable is related to the information indicating that the game ball 110 is about to be introduced to the game board. The information indicating that the entry to the game is closed is related to the information indicating that the game ball 110 is not about to be introduced to the game board.

When sending the information indicating whether the game ball 110 is about to be introduced to the game board or not to each second communication terminal 20 via the local area network 71 as instructed by the controller 12, the communicating device 15 also carries out the following process. The communicating device 15 also sends information indicative of an instruction to send the identifier of the pocket expected to receive the game ball 110 to each second communication terminal 20.

The first communication terminal 10 also includes an output device 16. By way of the communicating device 15, the controller 12 acquires the expected identification information and guest-specific information sent from each second communication terminal 20. The expected identification information sent from the second communication terminal 20 will be referred to as second expected identification information.

According to the instruction from the controller 12, the output device 16 outputs the first expected identification information items, their corresponding guest-specific information items, the second expected identification information items, and their corresponding guest-specific information items (information items acquired by the second acquiring device) to the manager 51 (e.g., dealer). These information items can be regarded as information required for proceeding with the game, since the manager 51 cannot proceed with the game unless the manager 51 acquires these information items.

According to the outputted result, the manager 51 carries out the operation of introducing the game ball 110 to the game board. As a result, the game ball 110 is received by any of the pockets 111a, . . . . The gaming device 11 acquires the identifier of the pocket having received the game ball 110, and sends thus acquired identifier to the controller 12. The controller 12 causes the output device 16 to output the identifier.

Then, the manager 51 carries out an operation of determining whether each guest 61 wins or loses the game. When the identifier of the pocket having received the game ball 110 and the expected identification information coincide with each other, for example, the manager 51 can determine that the guest 61 corresponding to the expected identification information wins the game. When the identifier of the pocket having received the game ball 110 and the expected identification information do not coincide with each other, the manager 51 can determine that the guest 61 corresponding to the expected identification information loses the game.

Each second communication terminal 20 includes a display device 23 and a controller 25.

According to the information managed by the controller 12 (managing device), the display device 23 displays that the game ball is about to be introduced to the game board. Specifically, the display device 23 displays the information indicating whether the game ball 110 is about to be introduced to the game board or not as sent from the first communication terminal 10. When displaying the information indicating that the game ball 110 is about to be introduced to the game board, the display device 23 also displays the information indicating that the entry to the game is currently accepted. When displaying the information indicating that the game ball 110 is not about to be introduced to the game board, the display device 23 also displays the information indicating that the entry to the game is closed.

When the newest information sent from the first communication terminal 10 is information indicating that the game ball 110 is about to be introduced to the game board, the display device 23 displays the information indicating that the game ball 110 is about to be introduced to the game board. When the newest information sent from the first communication terminal 10 is information indicating that the game ball 110 is not about to be introduced to the game board, the display device 23 displays the information indicating that the game ball 110 is not about to be introduced to the game board.

Each communication terminal 20 also includes an input device 21 and a card reader 22. When the display device 23 displays the information indicating that the entry to the game is currently acceptable together with the information indicating that the game ball 110 is about to be introduced to the game board, the card reader 22, input device 21, and controller 25 function as follows:

A guest 61 staying in a guest room brings a guest card closer to the card reader 22. Then, by noncontact communications, the card reader 22 reads out the guest-specific information specifying the guest 61 stored in the guest card. The card reader 22 sends the guest-specific information to the controller 25. According to the instruction information mentioned above, the controller 25 carries out the following process:

The display device 23 displays the instruction information. For example, the display device 23 displays an instruction to input the identification information of the pocket 111a, . . . expected to receive the game ball 110 (referred to as the second expected identification information). According to the display, the guest 61 inputs the second expected identification information by using the input device 21. The second expected identification information inputted by the input device 21 is sent to the controller 25.

According to the display effected by the display device 23, the controller 25 (acquiring device) acquires the identifier of the pocket expected to receive the game ball 110 inputted by the guest 61 and the guest-specific information. Specifically, the controller 25 acquires the information specifying the guest 61 (the guest 61 playing the game in the guest room), and the second expected identification information. Here, the second expected identification information is related to the guest-specific information.

Each second communication terminal 20 includes a communicating device 24. As instructed by the controller 25, the communicating device 24 sends the guest-specific information and the second expected identification information to the controller 12 of the first communication terminal 10 via the local area network 71.

Operation

Operations of the communication system 1 will now be explained. Here, it is assumed that the first display device 13 in the first communication terminal 10 and the display device 23 of each second communication terminal 20 display the information indicating that the entry to the game is currently acceptable together with the information indicating that the game ball 110 is about to be introduced to the game board.

The following operation is initially carried out in the game arcade. The guest 61 wishing to play the game brings the guest card closer to the card reader. Then, the guest-specific information read by the card reader is sent to the controller 12. The controller 12 causes the second display device to display an instruction to input the first expected identification information. According to the display, the guest 61 inputs the first expected identification information by using the identification information inputting section. The first expected identification information inputted by the identification information inputting section is sent to the controller 12. Thus, the first expected identification information items inputted by one or a plurality of guests 61 playing the game and the respective guest-specifying information items are sent to the controller 12. Then, the controller 12 acquires and holds the guest-specific information and first expected identification information for each guest 61 playing the game in the game arcade.

On the other hand, the following operation is carried out in each room. The guest 61 wishing to play the game brings the guest card closer to the card reader 22. Then, the guest-specific information read by the card reader 22 is sent to the controller 25. The controller 25 carries out the following operation according to the above-mentioned instruction information. The display device 23 displays the instruction information. According to the instruction information, the guest 61 inputs the second expected identification information by using the input device 21. The second expected identification information inputted by the input device 21 is sent to the controller 25. The controller 25 acquires the guest-specific information and second expected identification information of the guest playing the game. Then, as instructed by the controller 25, the transmitting device (communicating device) sends the guest-specific information and second expected identification information to the controller 12 of the first communication terminal 10 via the local area network 71.

Subsequently, the following operation is carried out in the first communication terminal 10 disposed in the game arcade. By way of the communicating device 15, the controller 12 acquires the second expected identification information and guest-specific information sent from each second communication terminal 20. Then, the controller 12 sends the first expected identification information items, their corresponding guest-specific information items, the second expected identification information items, and their corresponding guest-specific information items (information items acquired by the acquiring device), and an instruction to output these information items to the output device 16.

According to the instruction from the controller 12, the output device 16 outputs the first expected identification information items, their corresponding guest-specific information items, the second expected identification information items, and their corresponding guest-specific information items to the manager 51.

According to the output, the manager 51 carries out the operation of introducing the game ball 110 to the game board. As a result, the game ball 110 is received by any of the pockets 111a, . . . . The gaming device 11 acquires the identifier of the pocket having received the game ball 110, and sends thus acquired identifier to the controller 12. The controller 12 causes the output device 16 to output the identifier. Then, the manager 51 carries out an operation of determining whether each guest 61 wins or loses the game.

On the other hand, the manager 51 inputs the winning or losing information in relation to the guest-specific information by using the input device 18. According to the inputted guest-specific information, the controller 12 causes the first display device 13 to display the relationship between the guest-specific information and the winning or losing information. Also, by way of the communicating device 15, the controller 12 sends the information indicative of the relationship to the second communication terminal 20 in the guestroom where the guest 61 having played the game stays. The display device 23 of the second communication terminal 20 displays the above-mentioned relationship.

The following operation may also be carried out in the communication system 1. In this case, the card reader functions not only to read information but also to write information. The controller 12 holds the guest-specific information of the guest playing the game and the information specifying the card reader in relation to each other. In this case, card readers are allocated to the respective guests 61 one by one during gaming. According to the above-mentioned relationship, the controller 12 sends the winning or losing information corresponding to each guest-specific information to the card reader corresponding to the guest-specific information. When the card reader 22 is located within the second communication terminal 20, the winning or losing information is sent to the card reader 22 of the second communication terminal 20 via the communicating device 15 and local area network 71.

The winning or losing information may be written into the guest card when each guest 61 brings the guest card closer to the card reader.

In this embodiment 1, the controller (managing device) 12 of the first communication terminal 10 disposed in the game arcade manages whether the game ball 110 is about to be introduced to the game board or not. Then, the communicating device 15 (transmitting device) transmits the information managed by the controller (managing device) 12 and instruction information indicative of an instruction to transmit the identifier of the pocket expected to receive the game ball. The display device 23 in the second communication terminal 20 disposed in each guestroom can display the information indicating that the game ball 110 is about to be introduced to the game board and the instruction information according to the information managed by the controller (managing device) 12.

According to the display effected by the display device 23, the controller 25 (acquiring device) of the second communication terminal 20 disposed in each guestroom can acquire the identifier of the pocket expected to receive the game ball 110 as inputted by the guest 61 and the guest-specific information. The output device 16 of the first communication terminal 10 can output the information acquired by the controller 25 to the manager 51.

Therefore, according to the result outputted from the output device 16, the manager 51 can acquire the information required for proceeding with the game (the identifier of the pocket expected to receive the game ball 110) from the guest 61 playing the game while staying in a guestroom. As a result, the manager 51 can acquire the information required for proceeding with the game (identifiers of pockets expected to receive the game ball 110) from all the guests 61 playing the game. Hence, the manager 51 can proceed with the game even when a part of a plurality of guests 61 playing the game stay in their guestrooms, thereby determining whether each guest 61 wins or loses the game.

Therefore, this embodiment 1 makes it possible for the guest 61 to enjoy playing the game while staying in a guestroom of an accommodation facility, thereby providing the communication system 1 convenient for the guest of the accommodation facility.

From the guest 61 in the game arcade, the manager 51 can acquire the guest-specific information and first expected identification information by word of mouth or in writing as well.

### Embodiment 2

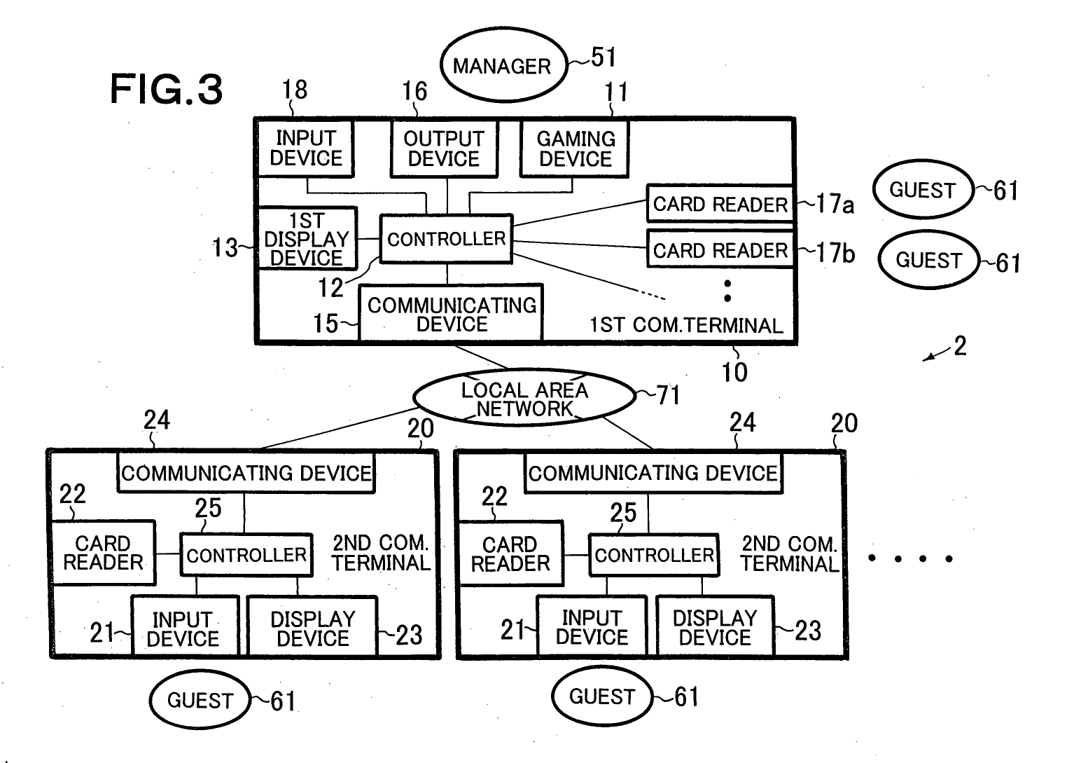

FIG. 3 is a diagram showing the configuration of the communication system 2 in accordance with an embodiment 2. In FIG. 3, constituents identical to those shown in FIG. 1 are referred to with numerals identical thereto. In this embodiment 2, functions identical to those of the constituents in the above-mentioned embodiment 1 will not be explained.

In the game of this embodiment 2, a plurality of game cards are supplied to each guest 61, and any of the game cards is replaced. An example of such a game is a poker game using playing cards. However, this embodiment 2 is not restricted to the poker game.

A manager 51 for managing a proceeding of the game carries out the following operations. At a predetermined position (position 1, 2, 3, . . . ), the manager 51 places a plurality of (e.g., 5) game cards to be supplied to each guest (guest 1, 2, 3, . . . ). In the proceeding of the game, the manager 51 carries out an operation of exchanging the game cards placed at the predetermined position with game cards not supplied to the guest 61. Also, the manager 51 carries out an operation of determining whether each guest 61 wins or loses the game according to a plurality of game cards held by the guest 61 after the lapse of a predetermined time, for example.

Each game card used in the game in the game arcade stores game card identification information which is identification information of the game card. Here, the game card is a playing card, for example. If the game card is the Ace of Hearts of playing cards, for example, the game card identification information is information specifying the Ace of Hearts.

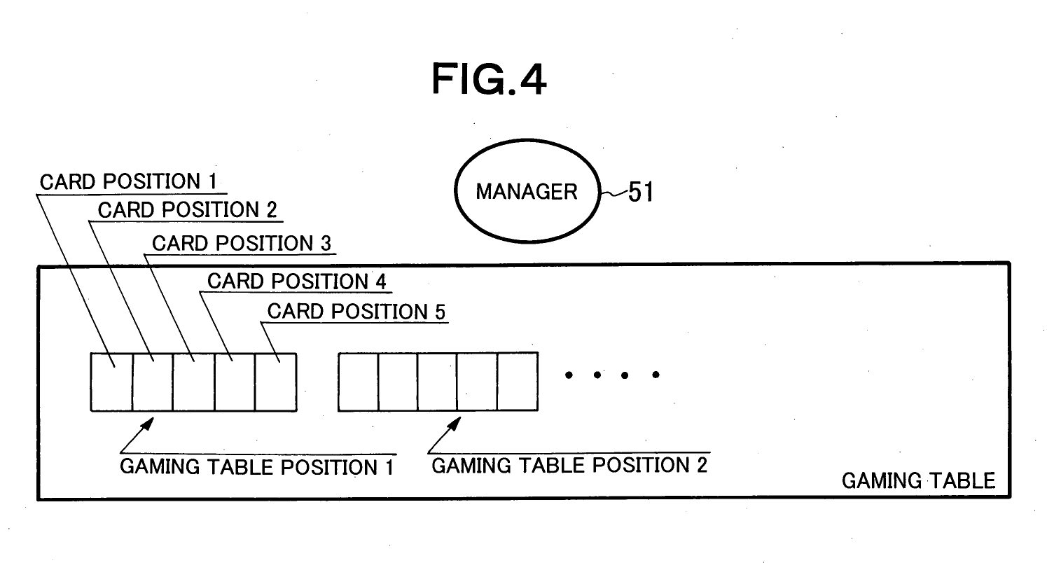

The configuration of the gaming device 11 in this embodiment 2 differs that in the above-mentioned embodiment 1 as will be explained in the following. FIG. 4 is a view showing the exterior configuration of a gaming table which is a part of the gaming device 11. The manager 51 is in the vicinity of the gaming table. Positions for placing a plurality of game cards are determined in the gaming table. For example, in the gaming table, gaming table position 1 for placing a plurality of game cards to be supplied to guest 1, and gaming table position 2 for placing a plurality of game cards to be supplied to guest 2 are determined. Thus, as shown in FIG. 4, a gaming table position (gaming table position 1, 2, 3, . . . ) for placing a plurality of game cards to be supplied to each guest (guest 1, 2, 3, . . . ) are determined in the gaming table.

Each gaming table position is divided into individual card positions for placing the respective game cards. When 5 cards are placed at the gaming table position 1, for example, the gaming table position 1 is divided into card position 1 for placing game card 1, card position 2 for placing game card 2, card position 3 for placing game card 3, . . . as shown in FIG. 4.

Disposed at each card position is a game card information acquiring device (not depicted) for acquiring the game card identification information stored in the game card placed at this card position.

A specific example of the acquiring operation effected by the game card information acquiring device will now be explained. For example, each game card incorporates an IC tag therein. The IC tag stores the game card identification information. The game card information acquiring device periodically sends instruction information which is information indicative of an instruction to transmit the game card identification information. The IC tag having acquired this instruction information transmits the game card identification information to the game card information acquiring device. This operation allows the game card information acquiring device to acquire the game card identification information of the game card placed at the card position.

In this embodiment 2, the first communication terminal 10 is provided a plurality of card readers 17a, 17b, . . . in place of the plurality of the guest input devices 14a, . . . . The card readers have the same functions as those of the card readers in the above-mentioned embodiment 1. The controller 12 manages whether the entry to the game is currently acceptable or not. The managing operation is carried out as in the above-mentioned embodiment 1 by the controller 12.

Operations of the communication terminal 2 in accordance with this embodiment 2 will now be explained. Here, it is assumed that the first display device 13 in the first communication terminal 10 and the display device 23 in each second communication terminal 20 display the information indicating that the entry to the game is currently acceptable.

The following operation is carried out in the game arcade. A guest 61 playing the game brings a guest card closer to the card reader 17a, . . . . Then, by noncontact communications, the card reader 17a, . . . reads out the guest-specific information stored in the guest card. This guest-specific information is sent to the controller 12. The controller 12 holds thus sent information specifying the guest 61 (guest 61 playing the game) in relation to the information indicating that the guest 61 is in the game arcade.

Also, the following operation is carried out in each guestroom. The guest 61 playing the game brings a guest card closer to the card reader 22. By noncontact communications, the card reader 22 reads the guest-specific information stored in the guest card. This guest-specific information is sent to the controller 25. The controller 25 relates thus sent information specifying the guest 61 (guest 61 playing the game while staying in the guestroom) to the information indicating that the guest 61 stays in the guestroom. Then, by way of the communicating device 24, the controller 25 sends the guest-specific information of the guest 61 playing the game and the information indicating that the guest 61 stays in the guestroom to the controller 12 of the first communication terminal 10.

The controller 12 of the first communication terminal 10 carries out the following process according to the held guest-specific information and the guest-specific information sent from each second communication terminal 20. The controller (first acquiring device) 12 acquires the guest-specific information of the guest 61 playing the game in relation to the information indicating that the guest 61 is in the game arcade or the information indicating that the guest 61 is in the guestroom. Then, the controller 12 causes the output device 16 to output information in which the guest-specific information of the guest 61 playing the game is related to the information indicating that the guest 61 is in the game arcade or the information indicating that the guest 61 is in the guestroom.

Subsequently, using the input device 18 of the first communication terminal 10, the manager 51 inputs starting of the game and guest-specific information items corresponding to the respective gaming table positions. The information items fed into the input device 18 are sent to the controller 12.

The controller 12 holds the relationship between the information specifying each gaming table position and the guest-specific information. For example, guest X is related to gaming table position 1, whereas guest Y is related to gaming table position 2. Then, the manager 51 places a plurality of (e.g., 5) game cards at each gaming table position (gaming table position 1, 2, . . . ). Each game card information acquiring device acquires the game card identification information from each game card placed at its corresponding card position in the gaming table position. Here, the game card identification information is related to the gaming table position and card position. Then, each game card information acquiring device sends thus acquired game card identification information to the controller 12.

When acquiring the game card identification information from each game card information acquiring device, the controller 12 carries out the following process. For each guest-specific information item of the guests 61 playing the game, the controller 12 (second acquiring device) acquires game card identification information items stored in a plurality of game cards in relation to information items indicative of the respective positions where the game cards are placed.

The following is a specific explanation. The controller 12 acquires the respective card identification information items stored in a plurality of game cards in relation to the respective game table positions where the game cards are placed. Also, the controller 12 holds the plurality of game card identification information items in relation to the respective card positions. According to the relationship mentioned above, the controller 12 holds the plurality of card identification information items in relation to the guest-specific information.

As a consequence, for each guest-specific information item of the guests 61 playing the game, the controller 12 acquires the game card identification information items stored in the plurality of game cards in relation to respective card position information items which are information items indicative of the positions where the game cards are placed (gaming table positions and card positions).

Then, the communicating device 15 (first transmitting device) transmits the game card identification information items of a plurality of game cards related to the guest-specific information corresponding to the information indicating that the guest 61 is in the guestroom, and the card position information items corresponding to the game card identification information items of the plurality of game cards to the second communication terminal 20 disposed in the guestroom where the guest 61 stays. The following is a specific explanation of this operation.

From among the guest-specific information items of the guests 61 playing the game, the controller 12 acquires the guest-specific information item related to the information indicating that the guest 61 is in the guestroom. Subsequently, the controller 12 acquires the plurality of game card identification information items corresponding to the above-mentioned guest-specific information item, and the card position information items corresponding to the respective game card identification information items. Then, according to the instruction from the controller 12, the communicating device (first transmitting device) 15 transmits the plurality of game card identification information items corresponding to the above-mentioned guest-specific information item, and the card position information items corresponding to the respective game card identification information items to the second communication terminal 20 disposed in the guestroom where the guest 61 stays. This operation of the communicating device 15 is carried out for each of guestrooms where the guests 61 playing the game stay.

When any of the plurality of game cards is desired to be replaced, the communicating device (second transmitting device) 15 transmits instruction information indicative of an instruction to transmit information concerning the game card desired to be replaced to the second communication terminal 20.

The following is a specific explanation of this operation. When the manager 51 inputs the instruction information by using the input device 18 of the first communication terminal 10, the instruction information is sent to the controller 12. The controller 12 sends the instruction information to the second communication terminal 20 to which the plurality of game card identification information items and card position information items were transmitted. This operation of transmitting the instruction information may be carried out together with the operation of transmitting the plurality of game card identification information items and card position information items.

The plurality of game card identification information items and card position information items transmitted by the communicating device 15 are displayed on the display device 23 by way of the controller 25 of the second communication terminal 20. The instruction information transmitted by the communicating device 15 is displayed on the display device 23 by way of the controller 25 of the second communication terminal 20.

According to the instruction information, the controller (third acquiring device) 25 of the second communication terminal 20 acquires the respective card position information items corresponding to the identification information items of one or a plurality of game cards desired to be replaced by the guest 61 from among the identification information items of a plurality of game cards if the guest 61 inputs information concerning the game card desired to be replaced. The following is a specific explanation.

When the guest 61 in a guestroom inputs information indicating that a game card is desired to be replaced by using the input device 21 according to the instruction information displayed in the display device 23, thus inputted information is sent to the controller 25. The controller 25 causes the display device 23 to display an instruction to input the card position information items corresponding to the respective card identification information items of one or a plurality of game cards desired to be replaced. According to the display effected by the display device 23, by using the input device, the guest 61 in the guestroom inputs the card position information items corresponding to the respective card identification information items of one or a plurality of game cards desired to be replaced. Thus inputted card position information items are sent to the controller 25.

The controller (third acquiring device) 25 acquires one or a plurality of card position information items inputted from the input device 23 in relation to the desire to replace the card. By way of the communicating device 24, the controller 25 sends the above-mentioned information items (the card position information items inputted from the input device and the desire to replace the card) to the controller 12 of the first communication terminal 10. This operation is carried out for each of the guestrooms where the guests 61 playing the game stay.

The controller 12 of the first communication terminal 10 causes the output device 16 to output one or a plurality of card position information items acquired by the controller 25 to the manager 51.

The manager 51 cannot proceed with the game unless the manager 51 acquires one or a plurality of card position information items mentioned above, whereby these information items can be regarded as information necessary for proceeding with the game.

Then, according to the above-mentioned output, the manager 51 can carry out the following operation. Namely, according to one or a plurality of card position information items, the manager 51 can carry out the operation of exchanging the game cards placed at their corresponding card positions with other game cards.

Here, a guest 61 in the game arcade playing the game can directly see a plurality of game cards placed at a game table position allocated to the guest 61. Also, this guest 61 can directly notify the manager 51 of a game card to be replaced. According to the notification from the guest 61, the manager 51 carries out the operation of exchanging the game cards.

According to this embodiment 2, even in a game using game cards among games played under the control of the manager 51, the manager 51 can acquire the information required for proceeding with the game as follows from the guest 61 playing the game while staying in a guest room.

The controller 12 (first acquiring device) of the first communication terminal 10 acquires the guest-specific information of the guest 61 playing the game in relation to the information indicating that the guest 61 is in the game arcade or the information indicating that the guest 61 is in the guestroom. Then, for each guest-specific information item of the guests 61 playing the game, the controller 12 (second acquiring device) of the first communication terminal 10 can acquire the game card identification information items stored in a plurality of game cards in relation to the respective card position information items.

Subsequently, the communicating device 15 (first transmitting device) of the first communication terminal 10 can transmit the respective game card identification information items of the plurality of game cards related to the guest-specific information corresponding to the information indicating that the guest 61 is in the guestroom, and the respective card position information items corresponding to the identification information items of the plurality of game cards to the second communication terminal 20 disposed in the guestroom where the guest 61 stays.

As a result, when the manager 51 supplies a plurality of game cards to the guest 61 in the guestroom, the respective game card identification information items of the plurality of game cards are displayed on the display device 23 of the second communication terminal 20 disposed in the guestroom. Therefore, the guest 61 in the guestroom can see the respective game card identification information items of the plurality of game cards.

Subsequently, to the second communication terminal 20, the communicating device (second transmitting device) 15 transmits instruction information indicative of an instruction to transmit information concerning any of a plurality of game cards desired to be replaced if any. According to the instruction information, the controller 25 (third acquiring device) in the second communication terminal 20 in each guestroom can acquire the respective card position information items corresponding to the game card identification information items of one or a plurality of game cards desired to be replaced by the guest 61.

Then, the output device 16 in the first communication terminal 10 can output one or a plurality of card position information items acquired by the controller 25 (third acquiring device) to the manager 51 as information required for proceeding with the game.

Therefore, according to the result outputted from the output device 16, the manager 51 can acquire the information required for proceeding with the game (information (card position information) concerning the game cards desired to be replaced by the guest 61 in the guestroom). As a result, the manager 51 can exchange the game cards corresponding to the card position information with other game cards, thereby carrying out the operation of exchanging game cards corresponding to the guest 61 in the guestroom.

Consequently, the manager 51 can proceed with the game even when a part of a plurality of guests 61 playing the game stay in their guestrooms, thereby determining whether each guest 61 wins or loses the game, for example.

Therefore, this embodiment 2 makes it possible for the guest 61 to enjoy playing the game while staying in a guestroom of an accommodation facility, thereby providing the communication system 2 convenient for the guest 61 of the accommodation facility.

Each guestroom may be provided with a camera (not depicted) for capturing image information indicative of the state within the guestroom (e.g., information showing the guest 61 playing the game). The output device 16 in the first communication terminal 10 may output the image information captured by the camera. As a consequence, the manager 51 can recognize the state within the room (the state of the guest 61 playing the game).

The above-mentioned embodiment 1 and embodiment 2 are similarly applicable to games using slot machines. Also, a communication system having both functions of the embodiment 1 and embodiment 2 can be realized. In this case, the second communication terminal 20 in the guestroom carries out the following operation. First, using the input device 21, the guest 61 inputs a desire to play a game. Then, the display device 23 displays information indicative of an instruction to choose any of game 1 (e.g., roulette game) and game 2 (e.g., poker game). Using the input device 21, the guest 61 inputs which game to select. Then, one of the operations of the embodiment 1 and embodiment 2 is carried out.

The game medium is not restricted to the game ball. For example, other media such as a coin, a medal or token can be used as well.

In the present invention, as explained in the foregoing, a manager can acquire information required for proceeding with a game from a guest. Therefore, the guest can enjoy playing the game while staying in a guestroom of an accommodation facility.

What is claimed is:

1. A communication system for acquiring information required for proceeding with a game played in a game arcade from a predetermined guest playing the game and outputting thus acquired information to a manager for managing the game,
the communication system comprising:
transmitting means, disposed in the game arcade, for transmitting instruction information indicative of an instruction to transmit the information required for proceeding with the game to a communication terminal of the guest; and
information acquiring means for acquiring information required for proceeding with the game according to the instruction information in the communication terminal.

2. A communication system according to claim 1, wherein the communication terminal comprises display means for displaying a predetermined information item according to the instruction information, and input means for causing the guest to input information required for proceeding with the game according to the predetermined information item displayed on the display means.

3. A communication system according to claim 1, wherein the communication terminal comprises card reading means for reading guest-specific information specifying the guest stored in a predetermined guest card.

4. A communication system for a game using a game board provided with a plurality of pockets adapted to receive a game medium introduced, each pocket bearing an identifier, a predetermined guest using a gaming device for causing any of the pockets to receive the game medium and anticipating the identifier of the pocket; the communication system acquiring from the guest the identifier of the pocket expected to receive the game medium before the game medium is introduced to the game board and outputting the identifier to a manager for managing the game;
the communication system comprising:
managing means, disposed in a game arcade where the game is played, for determining whether the game medium is about to be introduced to the game board;
transmitting means, disposed in the game arcade, for transmitting information managed by the managing means and instruction information indicative of an instruction to transmit the identifier of the pocket expected to receive the game medium to a communication terminal disposed in the guestroom in an accommodation facility;
display means, disposed in the guestroom of the accommodation facility, for displaying information indicating that the game medium is about to be introduced to the game board and the instruction information according to information managed by the managing means;
information acquiring means, disposed in the guestroom of the accommodation facility, for acquiring the identifier of the pocket expected to receive the game medium inputted by the guest and guest-specific information for specifying the guest according to the display effected by the display means; and
output means, disposed in the game arcade, for outputting the information acquired by the information acquiring means to the manager.

5. A communication system according to claim 4, wherein the communication terminal comprises communication means for transmitting the identifier of the pocket expected to receive the game medium inputted by the guest and the guest-specific information for specifying the guest as acquired by the information acquiring means.

6. A communication system according to claim 5, wherein transmission of information from the transmitting means to the communication terminal and the transmission of information from the communication means toward the game arcade are carried out via a local area network.

7. A communication system according to claim 4, wherein the guest-specific information is obtained by reading information specifying the guest stored in a predetermined guest card with at least card reading means disposed in the guestroom.

8. A communication system according to claim 7, wherein the card reading means is configured so as to be able to inscribe the predetermined guest card with a result of gaming transmitted from the game arcade.

9. A communication system according to claim 4, wherein the display means displays information indicating that an entry to the game is currently acceptable together with the information indicating that the game medium is about to be introduced to the game board.

10. A communication system according to claim 4, wherein the display means displays information indicating that the game medium is not about to be introduced to the game board.

11. A communication system according to claim 10, wherein the display means displays information indicating that the entry to the game is closed together with the information indicating that the game medium is not about to be introduced to the game board.

12. A communication system according to claim 4, wherein the guestroom of the accommodation facility is provided with input means for the guest to input the identifier of the pocket expected to receive the game medium.

13. A communication system according to claim 4, wherein the game is a roulette game.

14. A communication system for a game providing a predetermined guest with a plurality of game cards storing respective identification information items and then replacing any of the game cards, the communication system acquiring information required for proceeding with the game from the predetermined guest playing the game and outputting thus acquired information to a manager for managing the game;
the communication system comprising:
first information acquiring means for acquiring guest-specific information specifying a guest playing the game in relation to information indicating that the guest is in a game arcade where the game is played or information indicating that the guest is in a guestroom of an accommodation facility;
second information acquiring means for acquiring the identification information items stored in the plurality of game cards in relation to positional information items indicative of the positions where the game cards are arranged for each guest-specific information;
first transmitting means for transmitting the identification information items of the plurality of game cards related to the guest-specific information corresponding to the information indicating that the guest is in the guestroom and the positional information items respectively corresponding to the identification information items of the plurality of game cards to a communication terminal disposed in the guestroom where the guest stays;
second transmitting means for transmitting instruction information indicative of an instruction to transmit information concerning any of the game cards to the communication terminal if the game card is desired to be replaced;
third information acquiring means for acquiring the positional information item corresponding to the identification information item of one or a plurality of the game cards desired to be replaced by the guest in the identification information items of the plurality of game cards according to the instruction information in the communication terminal; and
output means, disposed in the game arcade, for outputting one or a plurality of positional information items acquired by the third information acquiring means to the manager.

15. A communication system according to claim 14, wherein the communication terminal comprises communication means for transmitting the positional information items corresponding to the identification information items of one or a plurality of the game cards desired to be replaced by the guest in the identification information items of the plurality of game cards as acquired by the third information acquiring means.

16. A communication system according to claim 14, wherein the guestroom of the accommodation facility is provided with display means for displaying the identification information items of the plurality of game cards related to the guest-specific information corresponding to the information indicating that the guest is in the guestroom and the positional information items corresponding to the identification information items of the plurality of game cards transmitted to the communication terminal.

17. A communication system according to claim 15, wherein the transmission of information from the transmitting means to the communication terminal and the transmission of information from the communication means toward the game arcade are carried out via a local area network.

18. A communication system according to claim 14, wherein the guest-specific information is obtained by reading information specifying the guest stored in a predetermined guest card with at least card reading means disposed in the guestroom.

19. A communication system according to claim 18, wherein the card reading means is configured so as to be able to inscribe the predetermined guest card with a result of gaming transmitted from the game arcade.

20. A communication system according to claim 14, wherein, when any of the game cards is desired to be replaced, the display means displays instruction information indicating an instruction to input information concerning the game card desired to be replaced.

21. A communication system according to claim 14, wherein the guestroom of the accommodation facility is provided with input means for inputting the positional information item corresponding to one or a plurality of the game cards desired to be replaced by the guest.

22. A communication system according to claim 14, wherein the identification information of each game card is stored in an IC tag incorporated in the game card.

23. A communication system according to claim 14, wherein the game is a poker game.

24. A communication system for acquiring information required for proceeding with a game played in a game arcade from a predetermined guest playing the game and outputting thus acquired information to a manager for managing the game;
the communication system comprising first and second communication system functions;
the first communication system function being employed for a first game using a game board provided with a plurality of pockets adapted to receive a game medium introduced, each pocket bearing an identifier, a predetermined guest using a gaming device for causing any of the pockets to receive the game medium and anticipating the identifier of the pocket, the first communication system function acquiring from the guest the identifier of the pocket expected to receive the game medium before the game medium is introduced to the game board and outputting thus acquired identifier to a manager for managing the first game;
the second communication system function being employed for a second game providing the predetermined guest with a plurality of game cards storing respective identification information items and then replacing any of the game cards, the second communication system function acquiring information required for proceeding with the game from the predetermined guest playing the second game and outputting thus acquired information to a manager for managing the second game;
the guestroom of an accommodation facility where the guest stays being provided with setting input means for the guest to input whether the first or second communication system function is used for playing the games, any of the first and second communication system functions being operated according to the input from the setting input means.

25. A communication system for acquiring information required for proceeding with a game played in a game arcade from a predetermined guest playing the game and outputting thus acquired information to a manager for managing the game;
the communication system comprising:
a transmitter, disposed in the game arcade, for transmitting instruction information indicative of an instruction to transmit the information required for proceeding with the game to a communication terminal of the guest; and
an information acquiring device for acquiring information required for proceeding with the game according to the instruction information in the communication terminal.

26. A communication system for a game using a game board provided with a plurality of pockets adapted to receive a game medium introduced, each pocket bearing an identifier, a predetermined guest using a gaming device for causing any of the pockets to receive the game medium and anticipating the identifier of the pocket; the communication system acquiring from the guest the identifier of the pocket expected to receive the game medium before the game medium is introduced to the game board and outputting thus acquired identifier to a manager for managing the game;
the communication system comprising:
a managing device, disposed in a game arcade where the game is played, for determining whether the game medium is about to be introduced to the game board or not;
a transmitter, disposed in the game arcade, for transmitting information managed by the managing device and instruction information indicative of an instruction to transmit the identifier of the pocket expected to receive the game medium to a communication terminal disposed in the guestroom in an accommodation facility;
a display device, disposed in the guestroom of the accommodation facility, for displaying information indicating that the game medium is about to be introduced to the game board and the instruction information according to information managed by the managing device;
an information acquiring device, disposed in the guestroom of the accommodation facility, for acquiring the identifier of the pocket expected to receive the game medium inputted by the guest and guest-specific information for specifying the guest according to the display effected by the display device; and
an output device, disposed in the game arcade, for outputting the information acquired by the information acquiring device to the manager.

27. A communication system for a game providing a predetermined guest with a plurality of game cards storing respective identification information items and then replacing any of the game cards, the communication system acquiring information required for proceeding with the game from a predetermined guest playing the game and outputting thus acquired information to a manager for managing the game;
the communication system comprising:
a first information acquiring device for acquiring guest-specific information specifying a guest playing the game in relation to information indicating that the guest is in a game arcade where the game is played or information indicating that the guest is in a guestroom of an accommodation facility;
a second information acquiring device for acquiring the identification information items stored in the plurality of game cards in relation to positional information items indicative of the positions where the game cards are arranged for each guest-specific information;
a first transmitter for transmitting the identification information items of the plurality of game cards related to the guest-specific information corresponding to the information indicating that the guest is in the guestroom and the positional information items respectively corresponding to the identification information items of the plurality of game cards to a communication terminal disposed in the guestroom where the guest stays;
a second transmitter for transmitting instruction information indicative of an instruction to transmit information concerning any of the game cards to the communication terminal if the game card is desired to be replaced;
a third information acquiring device for acquiring the positional information item corresponding to the identification information item of one or a plurality of the game cards desired to be replaced by the guest in the identification information items of the plurality of game cards according to the instruction information in the communication terminal; and
an output device, disposed in the game arcade, for outputting one or a plurality of positional information items acquired by the third information acquiring device to the manager.

28. A communication system for acquiring information required for proceeding with a game played in a game arcade from a predetermined guest playing the game and outputting thus acquired information to a manager for managing the game;
the communication system comprising first and second communication system devices;
the first communication system device being employed for a first game using a game board provided with a plurality of pockets adapted to receive a game medium introduced, each pocket bearing an identifier, a predetermined guest using a gaming device for causing any of the pockets to receive the game medium and anticipating the identifier of the pocket, the first communication system device acquiring from the guest the identifier of the pocket expected to receive the game medium before the game medium is introduced to the game board and outputting thus acquired identifier to a manager for managing the first game;
the second communication system device being employed for a second game providing the predetermined guest with a plurality of game cards storing respective identification information items and then replacing any of the game cards, the second communication system device acquiring information required for proceeding with the game from the predetermined guest playing the second game and outputting thus acquired information to a manager for managing the second game;
the guestroom of an accommodation facility where the guest stays being provided with a setting input device for the guest to input whether the first or second communication system device is used for playing the games, any of the first and second communication system devices being operated according to the input from the setting input device.
